(19) United States
(12) Patent Application Publication
(10) Pub. No.: US 2004/0245171 A1
(43) Pub. Date: Dec. 9, 2004

(54) Fabrication of filter elements using polyolefins having certain rheological properties

(76) Inventor: Mark Schimmel, Andover, CT (US)

Correspondence Address: CUNO INCORPORATED, 400 RESEARCH PARKWAY, P. O. BOX 1018, MERIDEN, CT, 06450-1018, US

(21) Appl. No.: 10/861,139

(22) Filed: Jun. 4, 2004

Related U.S. Application Data
(60) Provisional application No. 60/476,254, filed on Jun. 5, 2003.

(51) Int. Cl. B01D 29/085

(52) U.S. Cl. 210/497.01; 210/503; 210/505

(57) ABSTRACT

The present disclosure relates to filter elements and more particularly to filter elements prepared from improved polyolefin polymers, presently preferably polypropylene, characterized by a specific rheology. Most particularly, the present disclosure relates to polypropylene that has a specific molecular weight and molecular weight distribution, among other properties and/or characteristics, and/or polypropylene that has been adjusted in viscosity, molecular weight and molecular weight distribution, among other properties and/or characteristics, and its use in making depth filter elements. The present disclosure further relates to processes and/or systems for producing improved polyolefin polymers, e.g., polypropylenes and their use in fabricating advantageous filter elements.

### RELATED APPLICATIONS

This application is a continuation-in-part and claims priority to commonly owned U.S. Provisional Patent Application Ser. No. 60/476,254, filed Jun. 5, 2003, of Mark Schimmel., entitled “Controlled Rheology In Fabrication Of Filter Elements,” the disclosure of which is herein incorporated by reference to the extent not inconsistent with the present disclosure.

### BACKGROUND OF THE DISCLOSURE

The present disclosure relates to filter elements and more particularly to filter elements prepared from improved polyolefin polymers, presently preferably polypropylene, characterized by a specific rheology. Most particularly, the present disclosure relates to polypropylene that has a specific molecular weight and molecular weight distribution, among other properties and/or characteristics, and/or polypropylene that has been adjusted in viscosity, molecular weight and molecular weight distribution, among other properties and/or characteristics, and its use in making depth filter elements. The present disclosure further relates to processes and/or systems for producing improved polyolefin polymers, e.g., polypropylenes and their use in fabricating advantageous filter elements.

In order for a fluid cylindrical depth filter to provide acceptable filtration performance in an application, the filter must provide consistent particle removal efficiency over the filter's useful life, not unload or bypass previously captured contaminants as the differential pressure increases during service, provide a low initial differential pressure, provide a long useful in-service lifetime and exhibit low extractables when exposed to process fluids. It is also very important to have a reliable manufacturing process that provides consistency from lot to lot of the manufactured filters.

There are certain specific physical attributes of a cylindrical depth filter cartridge that typically result in the above mentioned preferred filtration performance characteristics. Cylindrical depth filter cartridges that have a sufficiently rigid fibrous structure so as not to deform over extended periods of use will typically provide the consistent particle removal efficiency over the filter's useful life and will not unload or bypass previously captured contaminants as the differential pressure increases during service. A cylindrical depth filter cartridge that has a high void volume and/or increased surface area will typically provide low initial differential pressure and a long in-service lifetime. Polyolefin polymers are known to provide low extractables in most process fluids.

The fabrication of filter elements using polypropylene is well known. There have been many attempts to make a depth filter cartridge that possess all of the preferred physical attributes stated above but typically they fall short in one or more areas, and therefore they do not achieve all of the desired filtration performance characteristics. For example, making a rigid cylindrical polypropylene depth filter cartridge often also creates a more dense low void volume fibrous structure, which results in a trade-off between consistent particle removal efficiency and low differential pressure and/or long filter lifetime. In another example, making a high void volume cylindrical polypropylene depth filter cartridge often yields a soft compressible fibrous media structure which requires a separate molded or metal central support core to keep the filter from collapsing under even low differential pressure. The resulting filter provides low differential pressure and long service lifetime but at the trade-off of consistent particle removal efficiency over its useful life and/or a tendency to unload or bypass previously captured contaminant as the differential pressure increases.

Attempts have been made to overcome the known problems. For example, grooved filters have been developed in an attempt to increase available filter surface area. However, conventional cylindrical depth filters fabricated from polypropylene have a tendency to melt, glaze, tear, shred, deteriorate and/or burr when machined in an attempt to provide an increased outer surface area. This machining often resulted in poor aesthetics and/or unacceptably short filter life. Several known commercially available products including those produced by Dyna-Jet Co., Korea and Hidrofilter, Brazil, are polypropylene depth filters provided with grooves, but these products are very heavy, dense and possess low void volumes, and, more importantly, appear to have glazed surfaces, and evidence short useful lifetimes. The presently known prior art available grooved filters are not entirely satisfactory because, among other shortcomings, they exhibit unacceptably short filter lifetime.

Other attempts have been made to produce cylindrical depth filters that do not utilize machining or grooving to address the above mentioned shortcoming. One technique that has been proposed is to create a graded structure which has a lower porosity/density at the exterior surface of the filter with progressively high porosity/density toward the center. Such a structure will permit contaminant to enter the matrix of the filter and in this way to utilize more of the depth filter's fibrous pore structure. However, the effectiveness of this graded porosity/density technique is very dependant upon the pore size distribution of the filter layers and the contaminant particle size distribution. In some applications the contaminant may penetrate and utilize the full depth of the filter, however, in other applications the contaminant may plug the pores of just one layer to yield a very short filter lifetime. Therefore, this particular type of depth filter structure is not believed to be optimized for all applications.

U.S. Pat. No. 3,801,400 discloses a depth filter cartridge that has varying density and U.S. Pat. No. 5,409,642 discloses a cartridge that can be produced with a graded porosity.

U.S. Pat. No. 5,591,335 discloses filtration medium formed of a mass of nonwoven meltblown support and filtration fibers which are integrally co-located with one another. The support fibers have, on average, relatively larger diameters as compared to the filtration fibers which are integrally co-located therewith. The filtration medium is disposed within at least one annular zone of a filtration element, as for example, a disposable cylindrical filter cartridge having an axial elongate central hollow passageway which is surrounded by the filtration media. According to this Patent, a depth filter cartridge is formed having one or more additional filtration zones (which additional filtration zones may or may not respectively be provided with integrally co-located support fibers) in annular relationship to one another. The blending in of large diameter fibers with the finer fibers also creates a graded fiber/porosity structure but still requires a supporting core.

U.S. Pat. No. 5,340,479 discloses a depth filter cartridge formed of a plurality of substantially continuous intertwined filaments including a central support zone formed of support filaments having a first diameter and a filter zone formed of filtration filaments having filaments of a second diameter in which the diameters are different or the filaments are constructed of different materials. The depth filter is a coreless, non-woven depth filter element and is a graded fiber element. The filaments include support filaments at the central area of the filter with diameters which are sufficiently large to thermally bind into a structure which is strong enough to support the remainder of the filter structure. By putting the finer fiber on the outside surface to increase the amount of area of the filtration media zone which is the opposite of the aforenoted graded porosity design and a coarser bonded fiber on the inside to form the fibrous core, the aforementioned is accomplished. Although locating the filtration media zone located on the outside of the depth filter increases the effective surface as compared to locating the filtration media zone on the inside of the depth filter, the filter will still likely exhibit a short filter lifetime because the exterior surface area of a cylindrical depth filter is still relatively low.

Another attempt is to produce a wound cartridge that allows a portion of the contaminant to pass unhindered through one layer to the next so as to make use of inner media layers that would otherwise be unused or under used. However, wound depth filters generally require many materials and components, which add to the complexity of cartridge assembly and cost thereof. U.S. Pat. No. 6,391,200 discloses a filter which includes alternating layers of filter medium and a diffusion medium. The alternating layers extend from a radially innermost layer of the filter element to a radially outermost layer of the filter element, the diffusion medium is defined by a continuous lengthwise sheet of mesh material, and the filter medium is defined by at least one sheet of filter material arranged along the length of the continuous sheet of mesh material. The alternating layers of filter medium and diffusion medium define three distinct radially disposed layered filtering sections surrounding a cylindrical core, and include a first filtering section having radially outer prequalifying layers, a second filtering section having middle prequalifying layers and a third filtering section having radially inner qualifying layers. The radially outer prequalifying layers and the middle prequalifying layers define about two-thirds of the radial distance from the radially outermost layer of the filter element to the radially innermost layer of the filter element. The filter material within the radially outer prequalifying layers includes a number of perforations forming radially extending by-pass apertures with lesser number of apertures in the middle prequalifying layers and none in the inner qualifying layers. The perforations formed by the pass-apertures provide improved fluid distribution over the filter medium, reduced pressure drop and increased service lifetime. However, the rather complex design makes the filters expensive to produce compared to filters made using other known meltblown processes.

In order to produce acceptable cylindrical depth filters made of polypropylene materials, it is necessary to use a modified polypropylene, one having a narrow molecular weight distribution and a lower molecular weight and/or an increased melt flow index so that the filters can be machined without quality degradation.

Typically, polypropylene produced with Ziegler-Natta catalysts has high molecular weights and broad molecular weight distributions. This is manifested as high melt viscosity with low melt flow index (“MFI”), which limits efficient processing and results in impaired product quality, particularly for applications as here intended.

Polymer material having desirable MFI (as a result of lower average molecular weight and narrower molecular weight distribution) could be theoretically obtained directly from synthesis, provided such synthesis method can be optimized and is industrially feasible. In reality, molecular weight and molecular weight distribution are difficult parameters to control in conventional propylene polymerizations, especially when employing Ziegler-Natta type catalysts. The use of metallocene catalysts in the propylene polymerization as substitutes for the Ziegler-Natta type catalysts has been proposed and represents a more favorable route for the synthesis of the polypropylene. However, control of such parameters during polymerization requires use of chain terminators or transfer agents and the results obtained are strongly dependent upon polymerization conditions.

In the prior absence of any commercially available materials having the desired properties, attempts have been made to overcome these problems by conducting post-synthesis processing. One such attempt is by blending resins of different molecular weights and/or molecular weight distributions. The difficulties associated with resin blending, however, have been reproducibility of blend composition and non-uniform molecular weight distributions.

Known post-synthesis processing methods directed to obtaining a narrow molecular weight and/or increasing the melt flow index of a polymer, e.g., polypropylene, are known as “modifying” or “controlling” the rheology of the polymer/polypropylene, i.e., changing the rheology to make the polypropylene acceptable for a given application. Viscosity reduction is also described as “viscbreaking”.

It has already been proposed to modify polypropylene so as to make the polypropylene suitable for a variety of end use applications. These end uses, however, require propylene polymers of different molecular weights and/or molecular weight distributions to achieve the variety of processing requirements which are encountered.

It has been found more expedient to degrade propylene polymers to the desired molecular weight range, rather than impose undue restrictions on the polymerization reaction. Typically, the polymer is subjected to an extrusion operation wherein thermal degradation is effected. It has been difficult, however, to achieve control over the ultimate molecular weight or molecular weight distribution in this manner. Further attempts have been made to controllably degrade propylene polymers by admixing air or another oxygen-containing gas with the propylene resin during the extrusion operation. Rather complex techniques have been developed to monitor and regulate extruder back pressure, screw speed, temperature and oxygen addition rate to attain control over the resultant molecular weight and molecular weight distribution. Additionally, these techniques require the use of high melt temperatures in order to obtain the higher melt flow rates required for many applications. The high melt temperatures often impart undesirable discoloration to the resultant product. Still further, if an oxygen source, such as a peroxide, is employed, the peroxide concentration required to effect sufficient degradation gives rise to odor problems in the final product and creates an undesirable environment surrounding the processing line which may be offensive to line workers.

Another process for viscosity reduction of polypropylene is extrusion at about 180-260° C. in the presence of an organic peroxygen compound (“peroxygen”). A typical organic peroxygen used commercially for this purpose is 2,5-dimethyl-2,5-di(t-butylperoxy)hexane, sold by Atofina Chemicals, Inc. as “Luperoxl®101”. This peroxygen is a liquid with assay between 91.0 to 93.0%, a melting point at 8° C. and active oxygen content of 10.03 to 10.25%. Alternatively this peroxygen can be currently obtained commercially in solid form with calcium carbonate as filler (Luperox®) 101XL45, assay 45.0 to 48.0%, active oxygen content 4.96 to 5.29%) or polypropylene as filler (Luperox®101PP20, assay 19.0 to 21.0%, active oxygen content 2.09 to 2.31%). Other organic peroxygen materials from the same chemical family may be employed in the viscosity reduction process.

A free radical mechanism is believed to account for polypropylene degradation by application of peroxygens, i.e., initially, the peroxygen decomposes to produce free radicals and these free radicals then abstract hydrogen from the tertiary carbon of the polyolefin backbone to form radicals on the polymer. This results in chain cleavage of the formed free radicals. The process can be terminated by recombination of the polymer free radicals.

### SUMMARY OF THE DISCLOSURE

It is an object of this disclosure to provide filter elements made from a polypropylene polymer exhibiting a melt flow index of about 35 to about 350, a molecular weight (Mₚ) of about 140,000 to about 180,000, and having a polydispersity less than 5.

Another object of the disclosure is to produce a polypropylene polymer, the viscosity and molecular weight distribution of which has been adjusted to result in a polypropylene which is particularly suitable for use in the production of filter elements which have advantageous characteristics.

Still another object of the disclosure is to produce in a reproducible, predictable and controllable manner polypropylene having a desired viscosity and molecular weight distribution to provide a polypropylene more acceptable for use in the fabrication of filter elements.

A still further object of the disclosure is to provide methods for producing filter elements from polypropylene.

Another object of the disclosure is to provide methods for producing filter elements from polypropylene that has been adjusted in viscosity and molecular weight distribution and, more particularly, from polypropylene having a reduced polymer molecular weight and narrowed molecular weight distribution based on changes in rheology (e.g., viscosity reduction of the polypropylene).

A still further object of the disclosure is to provide economic advantages which are presently believed to only be realized by effecting the desired polymer changes during the manufacturing operation.

One aspect of the present disclosure includes a filter element comprising: a polypropylene polymer exhibiting a melt flow index of about 35 to about 380, a molecular weight (Mₚ) of about 110,000 to about 180,000, a polydispersity less than 5 and a void volume greater than about 70%.

Another aspect of the present disclosure includes a process for producing a meltblown filter element from polypropylene comprising the acts of: prior to the extrusion thereof in molten form, subjecting polypropylene resin to controlled degradation to degrade the polypropylene resin such that the resultant resin exhibits a melt flow index of about 35 to about 380, a molecular weight (Mₚ) of about 110,000 to about 180,000, and a polydispersity less than 5; and extruding the resulting resin to form a filter element having a void volume of about 70%.

Still another aspect of the present disclosure includes a polypropylene polymer exhibiting a melt flow index of about 35 to about 380, a relative viscosity of about 200 to about 400 poise, a molecular weight (Mₚ) of about 110,000 to about 180,000, and a polydispersity less than 5 produced by controlled degradation such that a filter element produced therefrom has a void volume of about 70%.

Yet another aspect of the present disclosure includes a depth filter element, comprising: polypropylene having a MFI of from about 35 to about 380, a molecular weight (Mₚ) of about 110,000 to about 180,000, and a polydispersity less than 5 having a substantially tubular, substantially cylindrical shape

Other objects and aspects of the present disclosure are more fully set forth in the following description.

### DESCRIPTION OF THE DRAWING

FIG. 1 is a schematic illustration of a representative depth filter element in accordance with the present disclosure;

FIG. 2 is a schematic illustration of a further representative embodiment of a depth filter element construction in accordance with the present disclosure, illustrating the continuous production of a depth filter element(s) and exhibiting no bond joints;

FIG. 3 is a schematic illustration of a fulther representative embodiment of a depth filter element construction and including representative end caps, connectors and/or gaskets that are used to facilitate the use of the representative filters in a range of common filter housings;

FIGS. 3a and 3b are end views of representative end caps, connectors and/or gaskets of FIG. 3;

FIG. 4 is a schematic illustration of a another representative embodiment of a depth filter element construction and including representative end caps, connectors and/or gaskets that are used to facilitate the use of the representative filters in a range of common filter housings;

FIGS. 4a and 4b are end views of representative end caps, connectors and/or gaskets of FIG. 4;

FIG. 5 is a schematic illustration of another representative embodiment of a depth filter element construction and including representative end caps, connectors and/or gaskets that are used to facilitate the use of the representative filters in a range of common filter housings;

FIGS. 5a and 5b are end views of representative end caps, connectors and/or gaskets of FIG. 4;

FIG. 6 is a schematic illustration of yet another representative embodiment of a depth filter element construction and including representative end caps, connectors and/or gaskets that are used to facilitate the use of the representative filters in a range of common filter housings;

FIG. 7 is a schematic illustration of still another representative embodiment of a depth filter element construction and including representative end caps, connectors and/or gaskets that are used to facilitate the use of the representative filters in a range of common filter housings; and

FIG. 8 is a schematic illustration of still yet another representative embodiment of a depth filter element construction and including representative end caps, connectors and/or gaskets that are used to facilitate the use of the representative filters in a range of common filter housings.

### DETAILED DISCLOSURE OF EXEMPLARY EMBODIMENTS

In accordance with the present disclosure, it has now been found that, in the prior absence of commercially available polyolfins having desired properties, controlled degradation of a polypropylene starting material characterized by a high molecular weight (low MFI) and broad molecular weight results in a modified polypropylene that possesses desirable properties for use in fabricating filter elements in general and cylindrical depth filter elements in particular.

In one exemplary embodiment of the present disclosure, filter elements are fabricated from a polypropylene polymer exhibiting a melt flow index of about 35 to about 350, a molecular weight (Mₚ) of about 140,000 to about 180,000, and a polydispersity less than 5. The polypropylene polymer was grade EOD-99-10 received from Atofina Petrochemicals, Inc. of Houston, Tex.

In another exemplary embodiment of the present disclosure, in order to produce the desired polypropylene polymer exhibiting a melt flow index of about 35 to about 350, a molecular weight (Mₚ) of about 140,000 to about 180,000, and a polydispersity less than 5, controlled degradation is carried out thermally, with or without the use of oxygen, via radiation, or by the action of free radicals generated by one or more of various reagents such as peroxides when heated. The advantageous modification of the rheology and physical properties of the polypropylene are thus realized by controlled degradation of the polymer.

Unless indicated otherwise, the terms defined below have the following meanings:

The term “Melt Flow Index” or “MFI”, also variously referred to as MFR, or Melt Flow Rate—is defined in detail by test method ASTM 1238. The polymers in this disclosure were measured using the “method B” variant of the ASTM 1238 test method.

The term “molecular weight” refers to the molecular weight of a polymer (in this case polypropylene) and is defined by the molecular weight (the sum of the atomic weights of the constituent atoms of the molecule) of the repeat unit in the polymer chain (for example, propylene, the monomer of which polypropylene is made up, has a molecular weight of about 42.1) times the “degree of polymerization” —which is the number of repeat units in the polymer chain. Since the polymerization process is inexact, a range of polymer chain lengths will be produced—this leads to a distribution of molecular weights or “molecular weight distribution” or “MWD.” Two common units used to describe the molecular weight of a polymer are the “Number-average molecular weight”, or “Mₙ” and the “eight-average molecular weight” or “M_{w}”—Mₙ, tends to be a somewhat smaller value than the value at the peak of the molecular weight distribution curve. M_{w}, being a weight-average, emphasizes the longer, heavier molecules and tends to be a higher value. A third measure of molecular weight referenced is the “Peak molecular weight” or “Mₚ”—in the spectrographic analysis of polypropylene by GPC the peak of the distribution curve (the most probable molecular weight) is calculated.

The term “polydispersity” describes the molecular weight distribution of a polymer by the ratio M_{w}/Mₙ.

The term “meltblown process” refers to making fine fibers by extruding a thermoplastic polymer through a die consisting of one or more holes. As the fibers emerge from the die they are attenuated by an air stream that is run more or less in parallel or at a tangent to the emerging fibers.

The term “void volume” refers to a percentage calculated by measuring the weight and volume of a filter—then comparing the filter weight to the theoretical weight a solid mass of the same constituent material of that same volume. For example—a polypropylene filter may have a weight of 136 g and a volume of 584 cc-polypropylene polypropylene has a specific gravity of approximately 0.9. Therefore, the theoretical solid of the same volume would be about 584 cc*0.9 g/cc=524.6 g. The volume % polypropylene would be calculated by dividing the actual weight by the theoretical solid weight—or 136 g/524.6 g=25.9%. The void volume is 1 minus the volume % polypropylene—or in this case 1-0.259=0.741, or about 74%.

The term “thermal degradation” refers to the treating of a polymer with heat and the associated mechanical action typically present in an extruder, causing a scission of polymer chains.

The term “controlled degradation” refers to the reduction of molecular weight and the narrowing of the molecular weight distribution of a polymer by a controllable means—such by a specific heat and shear input rate—or by the introduction of an agent that breaks down the polymer chain—and is consumed in the degradation reaction—in proportion to a quantity of polymer.

The term “porosity” as used in this disclosure means the relative size of the pores or voids in the filter. Lower porosity referring to relatively smaller pores, higher porosity referring to relatively larger pores, graded porosity referring to a structure that exhibits a change in pore sizes in some designed or otherwise naturally occurring gradient throughout the depth of the filter.

The term “controlled rheology” may be defined as the use of radiation, peroxide or other free radical agent to adjust the rheological properties (such as viscosity and molecular weight distribution) of certain polyolefins, such as polypropylene, by degradation.

The term “densification” refers to a process described in the patent literature of some filter products whereby fibers which have been deposited either directly or indirectly onto a filter winding arbor or mandrel are compressed—either before or after said deposition—and made to form an area—either generally or locally—of lower porosity—whether by design or as an artifact of some process of handling the forming or formed filter.

Due to the random scission of polymer chains, the modified polymer, e.g., polypropylene, produced according to the advantage process(es) of the present disclosure has lower molecular weight (high MFI), narrower molecular weight distribution and possesses excellent mechanical strength and/or associated physical properties compared to the corresponding polymer previously directly synthesized from the monomer.

The rheological and physical properties of the polypropylene are controlled in accordance with one aspect of the present disclosure by adjusting the MFI of a starting polymer. According to representative exemplary embodiments of the present disclosure, the starting polypropylene has an MFI of approximately 35. Through the controlled modification of the starting polypropylene, the MFI is advantageously increased to approximately 160. Beginning with a polymer of a higher MFI than 40 may not be advantageous according to the present disclosure, particularly if the polymer is not of a narrow molecular weight distribution (MWD) before adjustment.

Theoretically, advantageous filter elements in general and cylindrical depth filter elements in particular according to the present disclosure could be fabricated using a narrow MWD polypropylene of 160 MFI or higher, for example up to about 350 MFI, or such filter elements could be made with less adjustment by using a narrow MWD polypropylene with a MFI greater than 40 but less than 160. Using a polymer of higher MFI than 160 may not be advantageous if the polymer does not have a narrow molecular weight distribution (“MWD”) before adjustment. Theoretically, advantageous filter elements could be fabricated using a narrow MWD polypropylene with a MFI in the desired range, e.g., about 160 and higher as are commercially available, as the starting material or the filter element could be made with less adjustment by using a narrow MWD polypropylene with an MFI greater than 40 but preferably less than 160.

In that regard, since we filed the provisional application, we have become aware of commercially available materials exhibiting these properties. We are uncertain as to how these specific material were made. Further, we have, since the provisional filing, successfully made filters using one of these commercially available materials that exhibit the desirable properties described earlier. Specifically, filters exhibiting desirable filtration properties have recently been made using polypropylene materials that are in the range of our preferred MFI without further adjustment by degradation, the polypropylene materials being received directly from the manufacturer. Typically, polypropylenes marketed as fiber grade (which typically exhibit narrow MWD from their manufacturers) will perform best according to the present disclosure, though grades intended for injection molding or extrusion may be—and have been—used successfully if during the process of adjustment they are modified from a wide MWD to a narrow MWD.

Thus, the preferred starting MFI of the polypropylene to be used according to the present disclosure is about 35 to about 350, a molecular weight (Mₚ) of about 140,000 to about 180,000, and having a polydispersity less than 5.

The disclosed rheology adjustment to polypropylene to be used that does not have these properties can be realized using various methods as have, for example, been set out above. According to one presently preferred exemplary embodiment of the present disclosure, the controlled modification is carried out by the addition of an organic peroxide, 2,5-dimethyl-2,5-di-tert-butylperoxy-hexane. This particular peroxide belongs to a group of peroxy alkanes which are resistant to shock and are stable against gradual decomposition upon storage. Despite the high degree of stability they are active degrading agents under convenient conditions of use. The starting polypropylene, which presently preferably has a MFI of about 35, is processed so as to adjust/modify the MFI to a final MFI of approximately 160.

One representative presently preferred method of executing the disclosed rheology modification process is by the addition of a solid form of the peroxide fed to the throat of an extruder. This could alternatively be done by the use of a liquid form of the peroxide and a metering pump as a feeder, or by making pre-blended batches of polymer and peroxide for loading into the hopper. One representative presently preferred method of controlling the amount of peroxide that is added is by synchronizing the feeder to run at a speed proportional to that of a positive displacement pump at the outlet of the extruder and before the die. This method (or the pre-blended method) generally benefits from inclusion of a quality control step in order to be sure the polymer rheology is being correctly adjusted.

Alternatively, the amount of peroxide could be controlled in proportion to the output of a control loop measuring the MFI with an online rheometer and controlling the speed of the feeder to maintain a set MFI. In this representative alternative method, a system is provided for the controlled degradation of the polypropylene preferably including an extruder-reactor, means for continuously monitoring a parameter of the molecular weight of the polypropylene and feedback means for changing the conditions in the extruder-reactor in response to the parameter of molecular weight measured. A continuous rheometer installed in the system is effective to measure the parameter of the molecular weight.

Assurance that the controlled degradation of the polypropylene has taken place to provide a polymer of the desired molecular weight is advantageous to the quality control effort for producing the most effective filter element and is accomplished by collecting a sample of polymer as it exits the die for MFI rheometer testing. Alternatively, samples generated by gently melting a representative section of a filter can be obtained and evaluated for determining the MFI of the polymer. For purposes of efficiency and economy, the former procedure is presently preferred.

Unless otherwise indicated, all numbers expressing quantities of ingredients, properties such as molecular weight, reaction conditions, and so forth used in the following are to be understood as being modified in all instances by the term “about.” Accordingly, unless indicated to the contrary, the numerical parameters set forth in the following claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Advantageous polypropylene materials exhibit a molecular weight (Mₚ) of about 140,000 to about 180,000 and more particularly, a molecular weight (Mₚ) of about 170,000, and a polydispersity less than 5. Materials meeting these properties allow the production of filter media product line of a broad range, in terms of nominal filter ratings of about 1 μm to about 75 or 100 μm or greater. Polypropylene materials of lower molecular weight and similar polydispersity may be used to make similarly effective filters at the tighter (lower micron rating) end of a product line, or even be used to make tighter filters than the about 1 μm to 100 μm range described. Conversely, polypropylene materials of higher molecular weight and similar polydispersity may be used to make similarly effective filters at the more open (higher micron rating) end of a filter product line, or even be used to make more open filters than the about 1 μm to about 100 μm range described.

The apparent viscosity of advantageous modified polypropylene materials according to the present disclosure is from about 200 to about 400 poise, as measured at a shear rate of about 700 to about 3500 reciprocal seconds.

The filter elements are typically produced using a melt blowing process. Melt blowing processes to produce meltblown products, such as non-woven mats from thermoplastic polymer resins, are known and are described in the literature, e.g., in U.S. Pat. Nos. 3,849,241, 3,755,527 and 3,978,185, the disclosures of which are incorporated herein by reference to the extent not inconsistent with the present disclosure.

One representative example of the process is illustrated as follows. Materials used included a polypropylene, such as, for example, Braskem H103 (from Braskem S.A. of Brazil) and an organic peroxide, such as, for example, Atofina Luperox 101. The equipment used in the process included an extruder designed for handling high MFI polymer, a hopper for directing the polypropylene into the throat of the extruder, an additive feeder for adding the organic peroxide to the throat of the extruder along with the polypropylene, as are known to those skilled in the art. Further, there may or may not be an on-line rheometer operatively positioned at the outlet of the extruder, there may or may not be a screen changer operatively positioned at the outlet of the extruder to filter the molten polypropylene and there may or may not be a positive displacement pump operatively positioned to accurately control the feed rate of the polypropylene. Still further, the representative example of the process would most likely include one of a variety of typical meltblown dies and related process air supply as would be known to one skilled in the art, and a cartridge winding mechanism operative to either make individual filters formed on a winding mandrel or on a rotating cantilevered shaft equipped with some sort of filter cartridge extraction device designed to substantially continuously pull/push the forming filter cartridge from the rotating shaft.

In operation, the process was started by introducing the polypropylene into the hopper of the extruder. The extruder pushed the polypropylene through the barrel, while substantially at the same time, an additive feeder added the organic peroxide material in proportion to the consumption of the polypropylene, as determined by the speed of the positive displacement pump, if present, the speed of the extruder, or as needed to maintain the correct parameters measured by the on-line rheometer.

If the on-line rheometer was not present, the process operator would need to perform an off-line MFI measurement and adjust the organic peroxide feed rate to achieve the desired MFI. In one representative example, the MFI was measured and the organic peroxide feeder was adjusted to maintain the polypropylene exiting the extruder at an MFI of about 160. The adjusted polypropylene was pumped by pressure through the meltblown die spinnerette resulting in the formation of fibers, as is known to those skilled in the art. The thus formed fibers were attenuated by the process air in the same manner as a typical meltblown process then collected on the rotating mandrel or shaft, as is known to those skilled in the art. The process adjustments that are typically used by those skilled in the art in the meltblown process, polymer melt temperature, process air rate and temperature, die temperature, polymer throughput, and die to collector distance, may all be used to vary the fiber size and the void volume of the resulting filter cartridge. However, the depth filter elements that were made using a meltblown process from polypropylene that has been purchased or modified by the described methods exhibited a void volume at least about greater than 70%, significant degree of fiber to fiber bonding, rigid self-supporting media structure that did not require a separate molded/extruded or densified fiber core (though there is nothing to prevent this process from being used to make filters consistent with this disclosure formed on such a support core), advantageous rigidity and machinability (the ability to have grooves cut in their exterior surface to increase life/throughput and/or reduce pressure drop without glazing and/or tearing) and the ability to be made to produce a wide range of particle retention ratings, beyond that of filter elements made from polypropylene of significantly higher or lower MFI, or wider molecular weight distribution without the requirement of a densification step or process. More particularly, filter elements fabricated according to the present disclosure exhibited advantageous properties when compared to filter elements fabricated from conventional polypropylene materials used for meltblown processing, which range from about 400 to greater than 1500 MFI, and the materials used in spunbond processes, which typically exhibit an MFI of about 35. None of these materials possesses the desired Theological properties and works as well as the controlled rheology materials described in the present disclosure in the manufacture of filter elements.

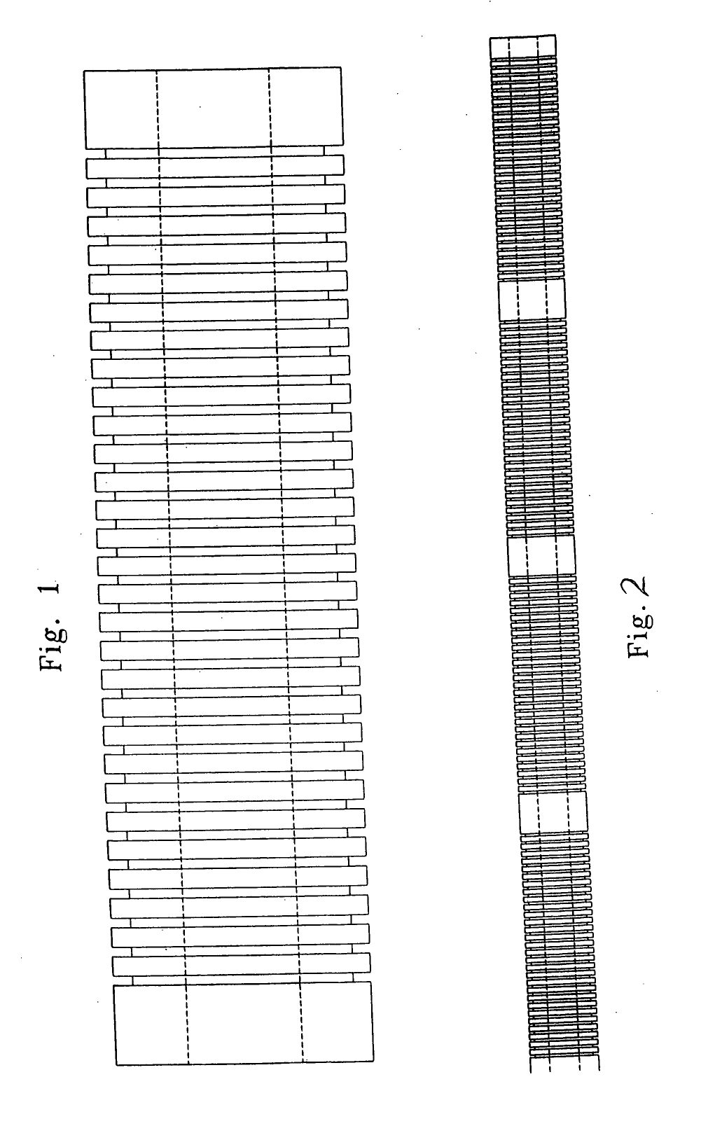

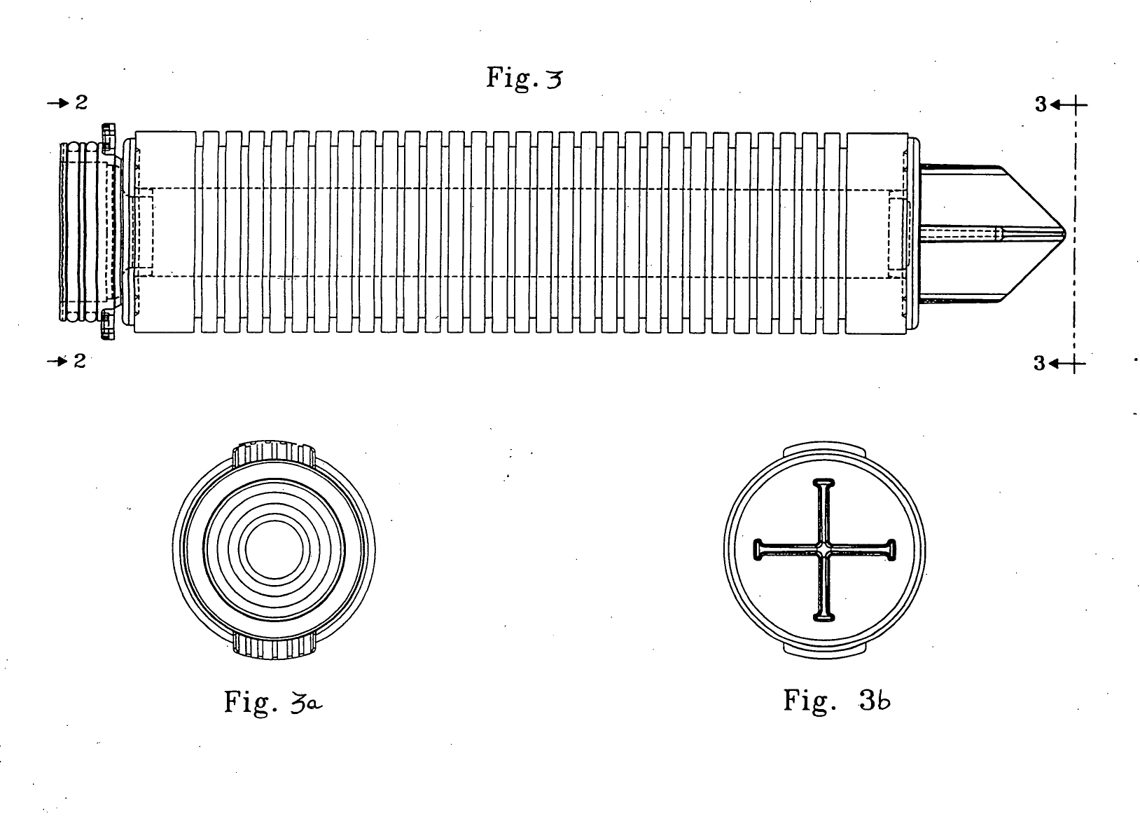

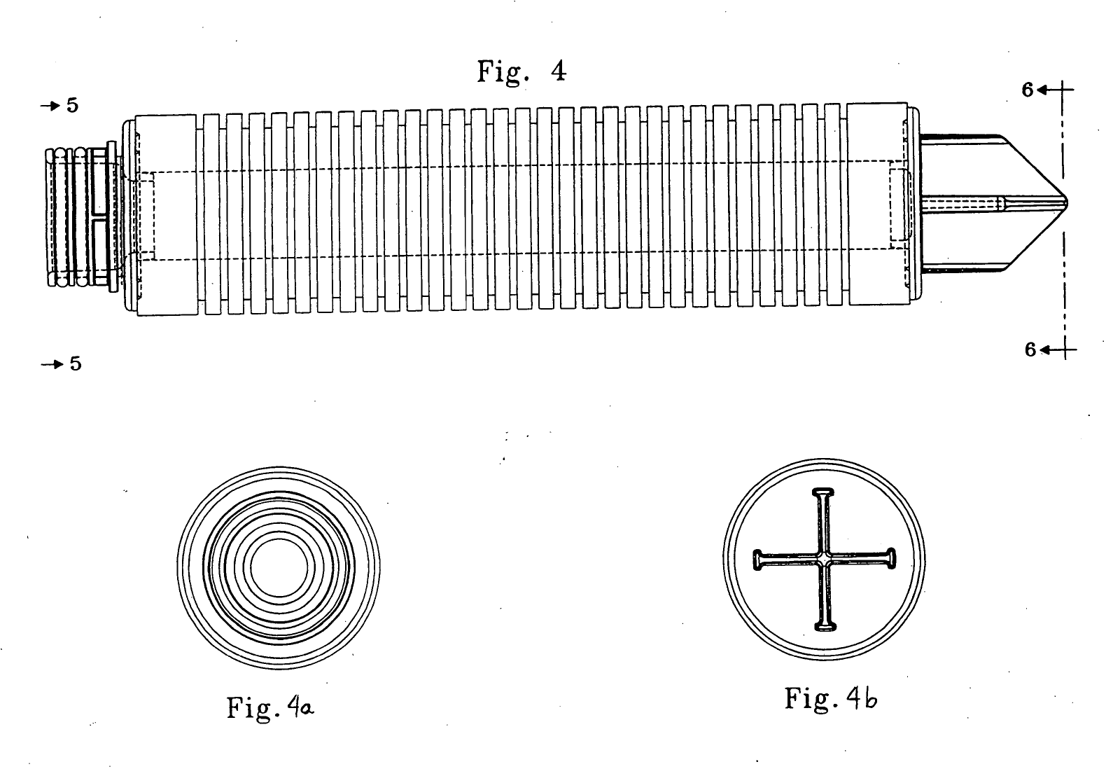

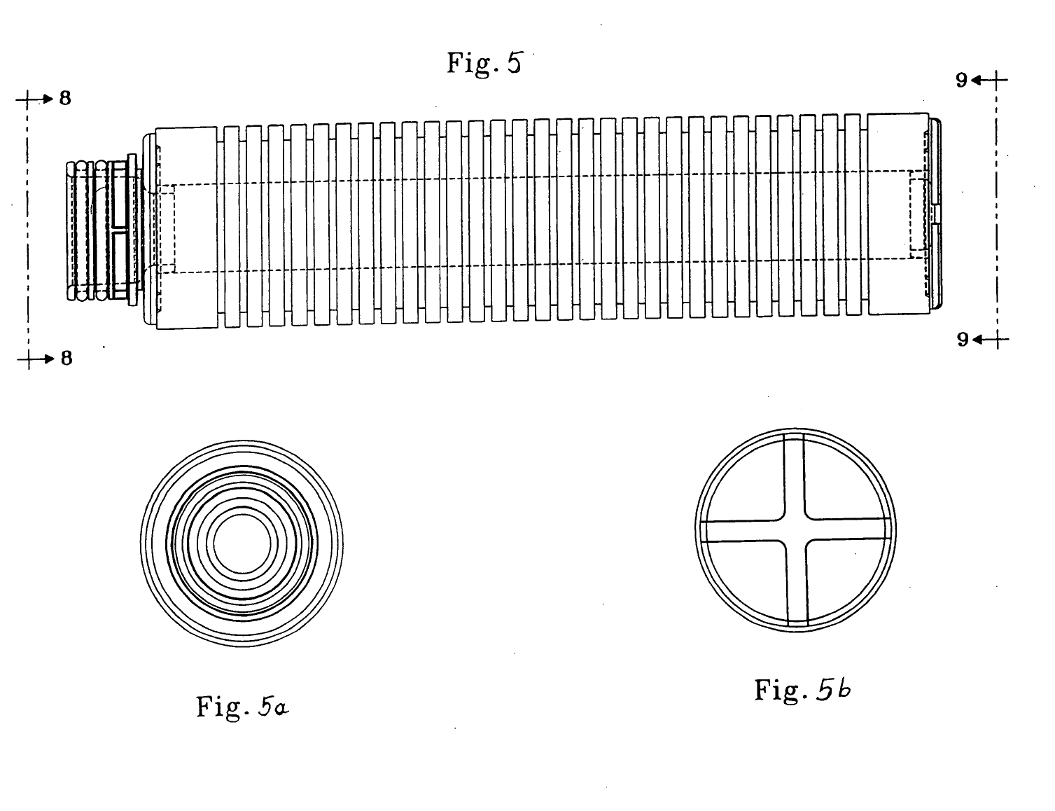

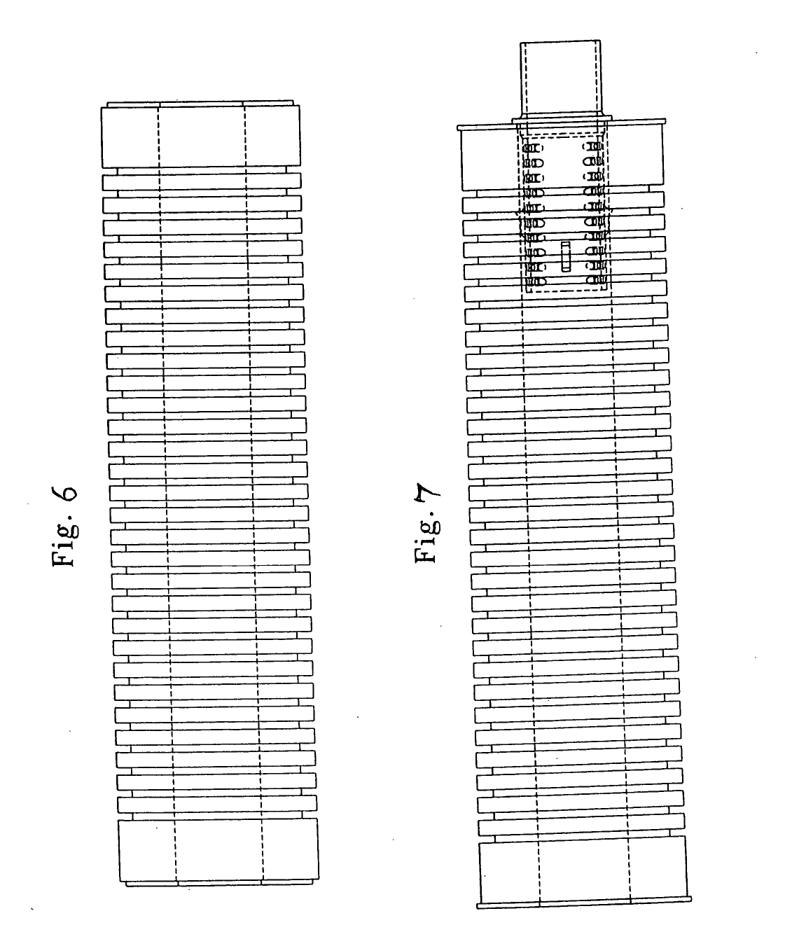

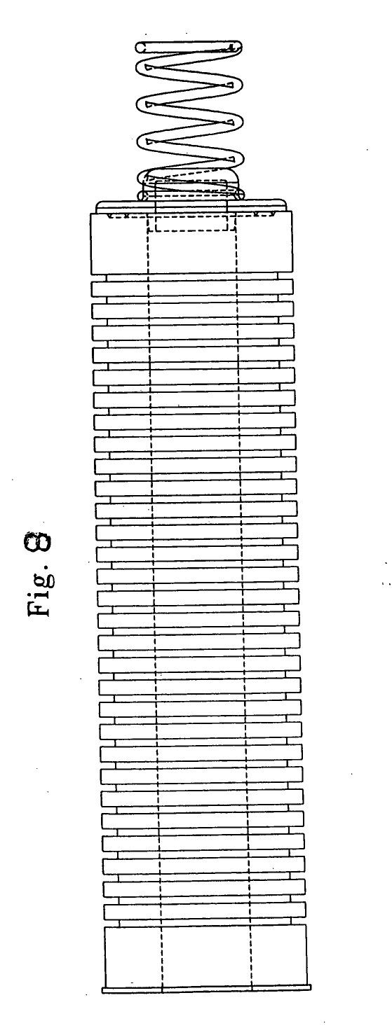

By using the modified polypropylene having desirable melt flow and molecular weight properties, and making a filter exhibiting a void volume greater than 70%, the performance and lifetime of the depth filter prepared by a melt blowing process can be extended by machining, e.g., grooving without adversely affecting the aesthetics of the product or creating unwanted glaze, tear, shred, burr of melt. The grooves can be cut in a manner and density according to the need. The grooves can be cut continuously or in groups separated by ungrooved sections as shown in FIGS. 1-3. The grooves may be cut in a circumferential manner or in a longitudinal manner covering parts or all of the length of the filter.

It is also possible for the grooves to be cut so that they form a continuous spiral groove extending on the outside of the filter element. Such spiral grooves can be provided over the entirety of the applicable outer surface or as a section separated by ungrooved sections. The filter element has been described as cylindrical or substantially cylindrical. It is contemplated that it could be produced in other shapes for example, elliptical depending to a considerable extent on the shape of the surrounding cartridge.

The filter manufacturing process disclosed in this disclosure, including polypropylene rheological modification and formation of the depth filter element is most suitably termed “Rigid Extrusion Bonded” (REB) technology, to differentiate it from the typical perception of the term “meltblown” as a fine fiber soft compressible nonwoven web or fiber such as disclosed in U.S. Pat. No. 4,594,202.

The resulting depth filter elements feature a high void volume—greater than 70%, a significant degree of fiber to fiber bonding as evidenced by a sufficiently rigid self-supporting media structure operable for the intended purpose, not requiring—though not necessarily excluding—a separate molded/extruded or densified fiber core. The resultant depth filter elements can be machined (grooved) to increase the exterior/interior surface area to increase life/throughput and reduce pressure drop, can be made to produce a wide range of particle retention ratings.

Representative filter elements are showed that the Figures. Specfically, FIG. 1 illustrates a representative filter element of the type described in this disclosure. FIG. 2 illustrates a representative filter element produced in a continuous length-exhibiting no bond joints-that is a useful resultant of the present disclosure. The remaining Figures are representative illustrations of the filters made according to the present disclosure that have been modified by the addition of various end caps, connectors and gaskets to facilitate the use of the resultant filters in a range of common filter housings, as would be known to those skilled in the art.

More particularly, filter elements fabricated according to the present disclosure exhibited advantageous properties when compared to filter elements fabricated from conventional polypropylene materials used for meltblown processing, which range from about 400 to greater than 1500 MFI, and the materials used in spunbond processes, which typically exhibit an MFI of about 35. Neither of these materials works as well as the controlled rheology materials described in the present disclosure in the manufacture of filter elements, as shown in Table 1 below.

TABLE 1

| | | | | | Polydis- | | |
|---|---|---|---|---|---|---|---|
| Line | Sample | Starting | | | persity | Void | |
| # | notes/description | Polymer | MFI | Mₚ | M_{W}/Mₙ | Volume | Actual Material Key |
| 1 | One starting resin | Braskem | 40 | 272716 | 4.40 | | |
| | | H103 | | | | | |
| 2 | Advantageous starting | Braskem | 158 | 172538 | 3.88 | 73% | A Standard filter of |
| | resin condition | H103 | | | | | adjusted H103 |
| 3 | Less preferred starting | Braskem | 70 | 181531 | 4.29 | | |
| | resin condition | H107 | | | | | |
| 4 | Workable starting resin | Braskem | 161 | 166330 | 4.73 | 74% | Experimental filter |
| | condition requiring | H107 | | | | | made with H107 |
| | greater energy input | | | | | | adjusted to 161 MFI |
| 5 | Makes desirable filter | Braskem | 192 | 153566 | 4.26 | 73% | Experimental filter |
| | cartridge at similar | H107 | | | | | made with H107 |
| | process conditions to | | | | | | adjusted to 192 MFI |
| | line 2 | | | | | | |
| 6 | Desirable filter cartridge | Atofina | 143 | 171542 | 4.60 | 77% | Experimental filter |
| | made with no resin | EOD-99- | | | | | made with Atofina |
| | rheology adjustment | 10 | | | | | EOD-99-10 specified |
| | | | | | | | as 120 MFI |
| 7 | Can be made into filters | Atofina | 377 | 112484 | 4.56 | 72% | Experimental filter |
| | only at the lower | 3960 | | | | | made with Atofina 3960 |
| | porosity end | | | | | | specified as 350 MFI |
| 8 | Pall Corporation Claris | | 193 | 138721 | 3.94 | 68% | |
| | CLR 3-10 filter cartridge | | | | | | |
| 9 | DYNA-WYND 10 μm | | 277 | 132237 | 3.41 | 60% | |
| | filter cartridge (of Korea) | | | | | | |
| 10 | GE Osmonics Hytrex | | 331 | 128265 | 3.36 | 60% | |
| | GXO3-10 filter cartridge | | | | | | |
| 11 | Hidrofilter ASEPP05 | | 363 | 142280 | 4.03 | 64% | |
| | filter cartridge (of Brazil) | | | | | | |
| 12 | GE Osmonics Z.Plex | | 743 | 116209 | 3.48 | 71% | |
| | RO.Zs 01 filter cartridge | | | | | | |

Lines 1, 3, 6, and 7 refer to test results of polypropylenes as-made by their respective manufacturers and where a void volume is shown, filters were made with out any rheology adjustments being made to the as received polymer.

The filter on line 2 is an example of a production sample of the preferred embodiment of the present disclosure.

The filter on line 4 is an experimental filter which exhibits all the desirable characteristics described in the present disclosure. This filter was made of polypropylene having a higher starting MFI than the presently most preferred starting material. When this material was adjusted to about 160 MFI there was no significant reduction in the polydispersity and in order to produce the desirable filter product required a greater input of energy in the production process compared to product shown on line 2.

The filter on line 5 is an experimental filter made of the same starting material as the filter on line 4. However, the MFI was increased to a point where the desirable filter characteristics were achieved when the process settings were the same as those required by the product shown on line 2.

The filter on line 6 was made with a material supplied by Atofina that complies with our specification for polypropylene material to make our desired product—as supplied by the manufacturer—with no further adjustment needed.

The filter on line 7 was made with a material supplied by Atofina that is higher than optimal to produce a full range of filter products. We were able to make a desirable filter at the lower porosity range of our current product line. We were also able to make significantly tighter filters than the current product line that may exhibit some or all of the desirable characteristics described in the present disclosure.

The filter on line 8 is a product made by Pall Corporation—Claris CLR 3-10—a 3 micron nominally rated filter. While the polymer of which the Claris filter is made is in a range that we claim to be able to make filters at the lower porosity range of our product structure, the lower than 70% void volume exhibited by this filter caused difficulty in attempts to machine grooves into it. Thus at least one reason why we believe the manufacturer does not groove this product. This filter also exhibits significantly higher clean pressure drops in service than a filter of similar efficiency made by the teachings of this disclosure.

The filter on line 9 is a product from R.O. Korea—DYNA-WYND 10 micron. This filter it is grooved by its manufacturer, though it exhibits a very low void volume and a resulting short in-service life.

The filter on line 10 is a product made by GE Osmonics-Hytrex GXO3-10—a 3 micron nominally rated filter. This product tears and burrs when attempts are made to machine grooves into its surface. It exhibits a very low void volume and a very high clean pressure drop in comparison to a filter of similar efficiency made by the teachings of this disclosure.

The filter on line 11 is a product made by Hidrofilter of Brazil. This is a product that is grooved by its manufacturer. The polypropylene material used in this filter could likely be used to make a range of desirable filters—but the void volume of this product is too low—leading to short in-service life and glazed surfaces in some places where it has been grooved.

The filter on line 12 is a product made by GE Osmonics—Z.Plex RO.Zs 01—a 1 micron nominally rated filter. This product exhibits the desired void volume—but because it is made with a polymer of a high MFI, the achievement of high void volume has come at the expense of significant fiber-to-fiber bonding. This product is soft and compressible—attempts to groove it result in tearing of the structure.

Thus, as can be seen from the above, filter elements made from material having the desirable properties or characteristics as described in the present disclosure achieve the desired performance while being machineable to form grooves in the surface thereof.

Although the present disclosure has been made with reference to specific exemplary embodiments thereof, the present disclosure is not limited thereto. Rather, modifications and/or variations to the disclosed exemplary embodiments may be made without departing from the spirit or scope of the present disclosure.

I claim

1. A filter element comprising:
a polypropylene polymer exhibiting a melt flow index of about 35 to about 380, a molecular weight (Mₚ) of about 110,000 to about 180,000, a polydispersity less than 5 and a void volume greater than about 70%.

2. The filter element of claim 1 wherein the filter element is made from polypropylene produced by controlled degradation.

3. The filter element of claim 1 wherein the filter element is made from polypropylene produced by the polymer manufacturer and used with out modification in the filter manufacturing process.

4. The filter element of claim 1 wherein the filter element is made by a melt blowing process utilizing rigid extrusion bonding, the filter element exhibiting a high degree of fiber to fiber bonding such that machining of the filter element is achieved without surface glazing or tearing.

5. The filter element of claim 4 wherein the polymer melt flow index comprises:
about 70 to about 270.

6. The filter element of claim 4 wherein the polymer melt flow index comprises:
about 120 to about 200.

7. The filter element of claim 4 having at least one groove operatively formed on the exterior surface thereof.

8. A filter according to claim 4 having at least one groove operatively formed on the interior surface thereof.

9. A process for producing a meltblown filter element from polypropylene comprising the acts of:
prior to the extrusion thereof in molten form, subjecting polypropylene resin to controlled degradation to degrade the polypropylene resin such that the resultant resin exhibits a melt flow index of about 35 to about 380, a molecular weight (Mₚ) of about 10,000 to about 180,000, and a polydispersity less than 5; and
extruding the resulting resin to form a filter element having a void volume of about 70%.

10. The process of claim 9 wherein the controlled degradation is accomplished by thermal means.

11. The process of claim 9 wherein the controlled degradation is accomplished by use of free radicals.

12. The process of claim 9 wherein the controlled degradation is accomplished by use of gamma radiation.

13. The process of claim 9 wherein the controlled degradation is accomplished by use of a bis(tert-alkyl peroxy)alkane.

14. The process of claim 13 wherein the bis (tert-alkyl peroxy) alkane comprises:
2,5-dimethyl-2,5-di-tert butyl peroxy-hexane.

15. The process of claim 9 wherein the controlled degradation is accomplished in a system comprising:
an extruder reactor; and
means, operatively connected to the extruder reactor, for continuously monitoring the parameter of the molecular weight of the polypropylene passing through the extruder reactor.

16. The process of claim 15 wherein the monitored parameter comprises:
the melt flow or other viscosity characteristic of the polypropylene.

17. The process of claim 15 wherein the continuously monitoring means comprises:
a continuous rheometer.

18. The process of claim 17 wherein said continuous rheometer includes feed back means for changing the conditions in the extruder-reactor in response to the parameter of molecular weight monitored.

19. A filter element made according the process of claim 9.

20. A depth filter element, comprising:
polypropylene having a MFI of from about 35 to about 380, a molecular weight (Mₚ) of about 110,000 to about 180,000, and a polydispersity less than 5 having a substantially tubular, substantially cylindrical shape.

21. The depth filter element of claim 20 wherein the element is self-supporting and coreless.

22. A polypropylene polymer exhibiting a melt flow index of about 35 to about 380, a relative viscosity of about 200 to about 400 poise , a molecular weight (Mₚ) of about 110,000 to about 180,000, and a polydispersity less than 5 produced by controlled degradation such that a filter element produced therefrom has a void volume of about 70%.
